(19) United States
(12) Patent Application Publication
(10) Pub. No.: US 2016/0052069 A1
(43) Pub. Date: Feb. 25, 2016

(54) TWIST DRILL WITH CERAMIC INSERTS

(71) Applicant: Kennametal Inc., Latrobe, PA (US)

(72) Inventor: Herbert Rudolf Kauper, Erlangen (DE)

(21) Appl. No.: 14/797,237

(22) Filed: Jul. 13, 2015

(30) Foreign Application Priority Data
Aug. 19, 2014 (DE) 102014111846.4

(51) Int. Cl. B23B 51/02

(52) U.S. Cl. CPC B23B 51/02; B23B 2226/18; B23B 2251/408; B23B 2251/50

(57) ABSTRACT

A twist drill includes a shank; a body adjacent the shank extending along a rotational, longitudinal axis of the twist drill, the body made of a carbide material; a plurality of helically extending chip flutes formed into the body with a web formed between the chip flutes, the chip flutes oriented at a helix angle relative to the longitudinal axis, each chip flute flanked by a major cutting edge with a corresponding flank or land and a minor cutting edge with a corresponding flank or land; and a ceramic insert attached to a notch formed in the body of the drill, wherein the ceramic insert forms only a portion of each of the major and minor cutting edges of the twist drill.

### BACKGROUND OF THE INVENTION

1. Field of the Invention

The invention relates to a drill for use in a machine tool, and in particular to a twist drill with ceramic inserts in the vicinity of the corner between the major and minor cutting edges for reducing wear and increasing the life of the drill.

2. Description of Related Art

At the present time, ceramics, owing to their high hardness and their very high temperature resistance, are being developed for the manufacture of cutting tools. Known ceramic cutting tools are generally milling cutter or turning tools and enable high-speed machining operations to be carried out on very hard materials. However, the possible constraints on a drill bit (drilling depth, removal of the chips, intensity and direction of the cutting forces) during a drilling operation are greater than those that may be applied on a milling cutter during a milling cutting operation. These constraints make it more difficult to use ceramic drill bits for carrying out drilling operations at very high speed in very hard materials, such as metal superalloys, cast iron, and the like.

### SUMMARY OF THE INVENTION

Drills have a rotational cutting speed at the center of the drill close to zero. As a result, material in the center will not be cut, but be pushed. Brittle material, such as ceramic, tends to break in the center of the drill. The problem of reducing or eliminating all breakage, particularly in the center of the drill, is solved by providing a rotary cutting tool, such as a twist drill, made of a combination of a tougher, grade-like material, such as carbide, and the like, in the center of the drill and a “super hard” material, such as ceramic, and the like, in the outer area of the cutting edge, thereby prolonging tool life, particularly under high speed cutting conditions.

In one aspect of the invention, a twist drill includes a shank and a body adjacent the shank extending along a rotational, longitudinal axis of the twist drill. The body is made of a carbide material. A plurality of helically extending chip flutes are formed into the body with a web formed between the chip flutes. The chip flutes are oriented at a helix angle relative to the longitudinal axis. Each chip flute is flanked by a major cutting edge with a corresponding flank or land, and a minor cutting edge with a corresponding flank or land. A ceramic insert is attached to a notch formed in the body of the drill, wherein the ceramic insert forms only a portion of each of the major and minor cutting edges of the twist drill.

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is a side view of a twist drill with ceramic inserts according to an embodiment of the invention;

FIG. 2 is another side view of the drill of FIG. 1;

FIG. 3 is an enlarged side view of the ceramic inserts of the twist drill of FIG. 1;

FIG. 4 is another enlarged side view of the ceramic inserts of the twist drill of FIG. 1;

FIG. 5 is an enlarged side view of an alternate embodiment of the ceramic inserts of the twist drill of FIG. 1;

FIG. 6 is an enlarged side view of the ceramic inserts of the twist drill of FIG. 5;

FIG. 7 is an enlarged side view of another alternative embodiment of the ceramic inserts of the twist drill of FIG. 1; and

FIG. 8 is another enlarged side view of the ceramic inserts of the twist drill of FIG. 7.

### DETAILED DESCRIPTION OF THE INVENTION

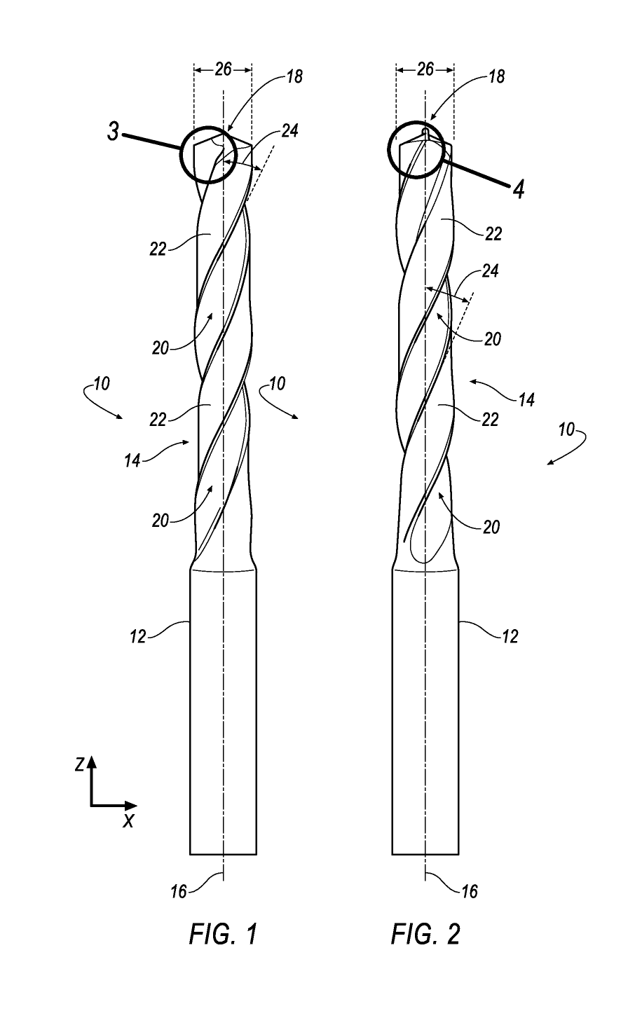

Referring now to FIGS. 1 and 2, a drill, such as a twist drill, is shown generally at 10 according to an embodiment of the invention. The drill 10 includes a shank 12 and a body 14 adjacent the shank 12 extending along a rotational, longitudinal axis 16 of the drill. The front end of the body 14 has a cutting end 18. The drill 10 also includes helically extending chip flutes 20 formed into the body 14 with a web 22 formed between the chip flutes 20. The chip flutes 20 are oriented at a helix angle 24 relative to the longitudinal axis 16. The drill 10 has a drill diameter 26 that slightly decreases in the direction of the shank 12.

In one embodiment of the drill 10, the body 14 is made of metal, for example, tool steel or a hard metal, for example, tungsten carbide, titanium carbide or titanium nitride. In another example, the body 14 is made of carbide material, such as cemented carbide material, and the like. In another example, the body 14 is made of a cermet comprising at least one hard component and a binder comprising cobalt, nickel, and iron, i.e., Co-Ni-Fe binder.

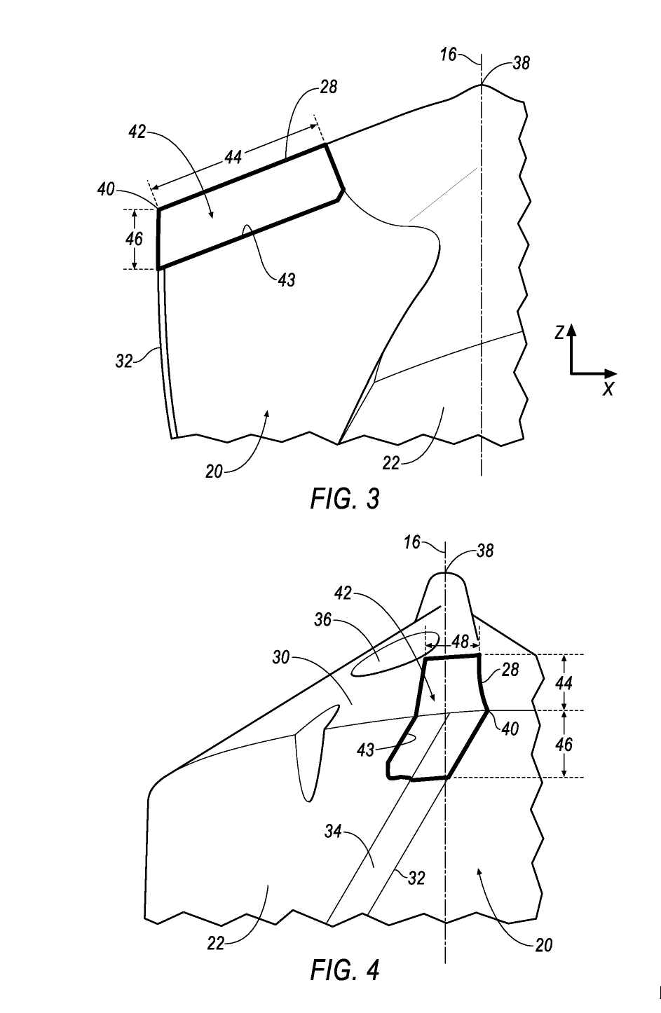

Referring now to FIGS. 3 and 4, each chip flute 20 of the drill 10 is flanked by a major cutting edge 28 with a corresponding flank or land 30, and a minor cutting edge 32 with a corresponding flank or land 34. On the drill 10 shown in FIGS. 1-4, there are two discharge orifices 36 located on the flanks 30 (only one orifice 36 is shown in FIG. 4), which are in fluid communication with a channel or channels (not shown) bored in the shank 12 and the body 14. The discharge orifices 36 are preferably located in an area of the drill 10 in which coolant and/or lubricant is fed to the vicinity of the point of application, i.e., to the area of the drill 10 adjacent to the major cutting edges 28. For example, the discharge orifices 36 can be located on the flanks 30 in the vicinity of a tip 38 and/or a corner 40 at an intersection between the major and minor cutting edge 28, 30 of the drill 10.

One aspect of the invention is that a portion of each major cutting edge 28 and a portion of each minor cutting edge 32 of the drill 10 is made of a material having different material properties than the body 14 of the drill 10. Specifically, the drill 10 includes a ceramic insert, shown generally at 42, that forms only a portion of the major and minor cutting edges 28, 32. The ceramic insert 42 is attached to a notch 43 having a corresponding shape formed in the body 14 of the drill 10. The ceramic insert 42 can be attached to the body 14 using any well-known means in the art, such as glueing, and the like. It has been surprisingly found that glueing the ceramic insert 42 to the body 14 produces a beneficial dampening effect. In one embodiment, the ceramic insert 42 is made of any suitable ceramic material. For example, the ceramic insert 42 can be made of an oxide ceramic, for example, aluminum oxide, a mixed oxide based on aluminum oxide, and a non-ceramic material, such as, silicon nitride, diamond or boron nitride. In one specific example, the ceramic insert 42 can be made of a whisker-reinforced ceramic material, such as a type described in U.S. Pat. No. 5,141,901.

As shown in FIGS. 3 and 4, the ceramic insert 42 forms only a portion of the major and minor cutting edges 28, 32 in the vicinity of the corner 40. Specifically, the ceramic insert 42 has a width 44 in the radial direction (in the direction of the x-axis) extending from the corner 40 to form a portion of the major cutting edge 28 of approximately one-third to two-thirds of the distance from the corner 40 to the tip 38. In the illustrated embodiment, the width 44 is about one-half the distance to the tip 38. In other words, the ceramic insert 42 extends from the corner 40 in the radial direction (in the direction of the x-axis) for a width 44 of about one-quarter of the drill diameter 26.

In addition, the ceramic insert 42 has a depth 46 in the axial direction (in the direction of the z-axis) that extends from the corner 40 to form a portion of the minor cutting edge 32 that is less than or equal to the width 44 of the ceramic insert 42. In other words, the ceramic insert 42 extends from the corner 40 in the axial direction for a depth 44 of less than the width 42 in the radial direction.

Further, the ceramic insert 42 has a length 48 that extends from the corner 40 to form a portion of the web 22 and the flank 30 corresponding to the major cutting edge 28 and the flank 34 corresponding to the minor cutting edge 32. In the illustrated embodiment, the length 48 is less than or equal to the width 44 of the ceramic insert 42 forming a portion of the major cutting edge 28 and is substantially equal to the depth 46 of the ceramic insert 42 forming a portion of the minor cutting edge 32.

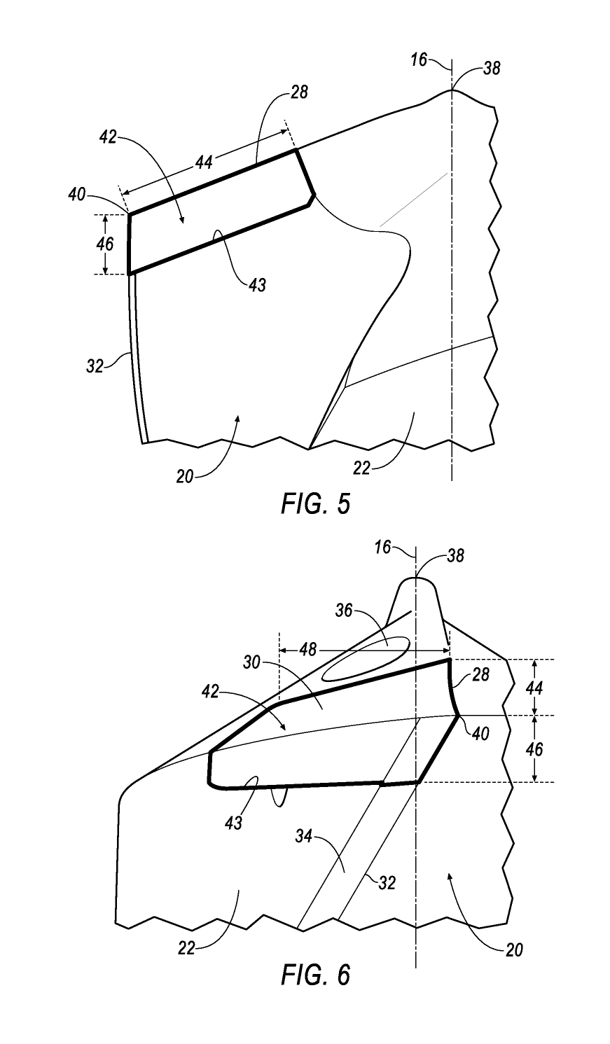

It will be appreciated that the invention is not limited to the specific dimensions of the ceramic insert 42, and that the invention can be practiced with many different dimensions, so long as the ceramic insert 42 forms only a portion of the major and minor cutting edges 28, 32. For example, FIGS. 5 and 6 show the ceramic insert 42 having different dimensions than the ceramic insert 42 shown in FIGS. 3 and 4. Specifically, the width 44 and the depth 46 of the ceramic insert 42 shown in FIGS. 5 and 6 is substantially identical to the width 44 and the depth 46 of the ceramic insert 42 shown in FIGS. 3 and 4. However, the length 48 of the ceramic insert 42 shown in FIGS. 5 and 6 extending into the web 22 and the flanks 30, 34 is greater than the length 48 of the ceramic insert 42 shown in FIGS. 3 and 4. In this embodiment, the length 48 is approximately equal to the width 44 of the ceramic insert 42. Thus, the ceramic insert 42 shown in FIGS. 5 and 6 has a greater volume than the ceramic insert 42 shown in FIGS. 3 and 4.

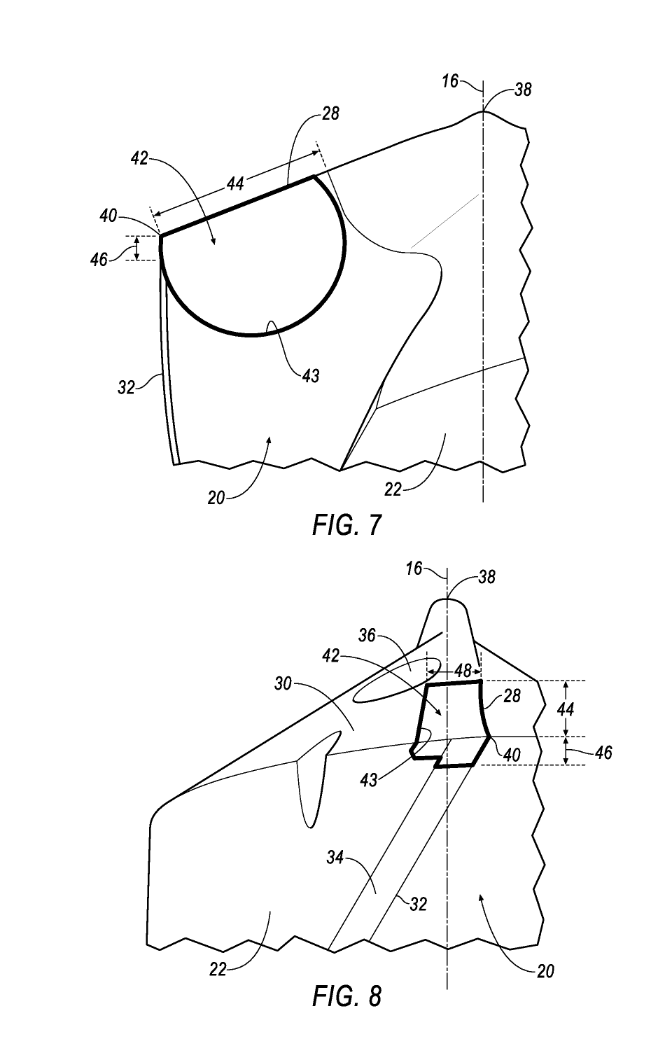

The ceramic insert 42 shown in FIGS. 3-6 is generally rectangular in shape having substantially planar surfaces. However, it will be appreciated that the invention is not limited to the shape of the ceramic insert 42, and that the invention can be practiced with any desirable shape for the ceramic insert 42, so long the ceramic insert 42 forms only a portion of the major and minor cutting edges 28, 32. For example, the ceramic insert 42 can have a non-planar surface, as shown in FIGS. 7 and 8. Specifically, the depth 46 and length 48 of the ceramic insert 42 shown in FIGS. 7 and 8 is substantially identical to the depth 46 and the length 48 of the ceramic insert 42 shown in FIGS. 3 and 4. However, the depth 46 of the ceramic insert 42 shown in FIGS. 7 and 8 is variable, unlike the depth 46 of the ceramic insert 42 shown in FIGS. 3 and 4, which is substantially uniform. More specifically, the depth 46 of the ceramic insert 42 is circular in shape, as shown in FIG. 7. Thus, the ceramic insert 42 shown in FIGS. 7 and 8 has a greater volume than the ceramic insert 42 shown in FIGS. 3 and 4.

It has been found that the ceramic insert 42 of the invention produces high wear resistant, sharp major and minor cutting edges 28, 32, particularly in the vicinity of the corner 40 that is prone to excessive and premature wear, resulting in an increase in tool life.

The patents and publications referred to herein are hereby incorporated by reference.

Having described presently preferred embodiments the invention may be otherwise embodied within the scope of the appended claims.

1. A twist drill, comprising:
a shank;
a body adjacent the shank extending along a rotational, longitudinal axis of the twist drill, the body made of a carbide material;
a plurality of helically extending chip flutes formed into the body with a web formed between the chip flutes, the chip flutes oriented at a helix angle relative to the longitudinal axis, each chip flute flanked by a major cutting edge with a corresponding flank or land and a minor cutting edge with a corresponding flank or land; and
a ceramic insert attached to a notch formed in the body of the drill, wherein the ceramic insert forms only a portion of each of the major and minor cutting edges of the twist drill.

2. The twist drill according to claim 1, wherein the ceramic insert has a width in a radial direction extending from a corner at an intersection between the major and minor cutting edges to a tip of approximately one-third to two-thirds of a distance from the corner to the tip of the twist drill.

3. The twist drill according to claim 2, wherein the ceramic insert has a depth in an axial direction extending from the corner to form a portion of the minor cutting edge that is less than or equal to the width of the ceramic insert.

4. The twist drill according to claim 3, wherein the ceramic insert has a length that extends from the corner to form a portion of the web and the flank corresponding to the major cutting edge and the flank corresponding to the minor cutting edge, and wherein the length is less than or equal to the width of the ceramic insert and is substantially equal to the depth of the ceramic insert.

5. The twist drill according to claim 1, wherein the ceramic insert has a non-planar surface.

6. The twist drill according to claim 1, further comprising discharge orifices located on the flank of the major cutting edge of the twist drill.
